(19) United States
(12) Patent Application Publication
(10) Pub. No.: US 2002/0067656 A1
(43) Pub. Date: Jun. 6, 2002

(54) Dynamic mixer

(76) Inventor: Heinrich Schuchardt, Leverkusen (DE)

Correspondence Address: BAYER CORPORATION, PATENT DEPARTMENT, 100 BAYER ROAD, PITTSBURGH, PA, 15205, US

(21) Appl. No.: 09/905,555

(22) Filed: Jul. 13, 2001

(30) Foreign Application Priority Data
Jul. 17, 2000 (DE) 10034621.9

(51) Int. Cl. B01F 7/08

(52) U.S. Cl. 366/80; 366/318

(57) ABSTRACT

A dynamic mixer is described comprising at least one housing with two or more inlets for the mixing components and an outlet as well as a shaft with a screw thread and a drive means for the rotation of the shaft, as well as a process for the mixing of highly reactive educts. The mixer has a mixing zone in which oppositely directly threaded grooves are present on the shaft and on the internal wall of the housing, and at least one inlet is arranged in the mixing zone with oppositely directed threaded grooves.

### BACKGROUND OF THE INVENTION

The invention relates to a dynamic mixer comprising of at least one housing with two or more inlets for the mixing components and an outlet as well as a shaft with a screw thread and a drive means for the rotation of the shaft. The invention also relates to a process for mixing highly reactive educts. The mixer has a zone in which oppositely directed threaded grooves are present on the shaft and on the internal wall of the housing, and at least one inlet is arranged in the said zone with oppositely directed threaded grooves.

When mixing educts that react with very short reaction time (<100 msec) to form highly viscous products, the mixing equipment has to meet particularly stringent requirements.

An important reaction is for example the conversion of diisocyanates with diamines and/or dialcohols to form polyurethanes or polyurethane ureas. For example, elastic yarns are produced by reacting the solution of a prepolymer containing two isocyanate functions with diamines for form polyurethane spinning solutions. In this connection the reaction times of an ideal mixture are far below one second. The spinning solution that is obtained has a viscosity that is typically in the region of 100 Pa·s, and is used for example for the dry spinning of elastans.

If a narrow molecular weight distribution is desired, then the mixing of the staring materials must take place as far as possible within the reaction time of the ideal mixture.

An evaluation of known mixers shows that up to now there has been no satisfactory solution to this mixing problem.

Static mixers (described for example in U.S. Pat. No. 4,062,524) do not achieve the requisite short mixing time (<100 ms).

Similarly, extruders have a mixing time that is generally above one second.

An example of an extruder with a zone provided with oppositely directed threads is described in U.S. Pat. No. 4,136,969. The extruder is used to plasticize rubber and utilize the zone to comminute the rubber material. Use as a dynamic mixer is not envisaged in the specification. Also, there is no inlet in the region of the aforementioned zone for the materials being mixed.

Nozzle systems for the aforementioned polyurethane production process are known from EP 579 979 A2, and also have disadvantages.

With conventional rotor-stator mixers, in which the product is conveyed by an alternating series of stationary and rotating toothed discs, the product is subjected only to a small number of mixing interventions, typically less than 10, with the result that a good mixing under laminar flow conditions is only possible if a good premixing already exists at the inlet.

The object of the invention is accordingly to provide a device with which also highly viscous reactive systems can be optimally mixed under extremely short reaction times.

### BRIEF DESCRIPTION OF THE DRAWINGS

FIG. 1a is a side view of a mixer according to the invention, the housing is being shown in section.

FIG. 1b is a section through the mixer of FIG. 1a along the line A-A.

FIG. 2 is a longitudinal section of the house of the mixer from FIG. 1a.

FIG. 3 is a perspective view of the housing and the shaft of the mixer of FIG. 1a next to one another.

FIG. 4 shows the housing of a mixer with an annular groove in the region of the inlet (2).

### DESCRIPTION OF THE INVENTION

This object is achieve according to the invention by a dynamic mixer, which is the subject of the invention, and which comprises at least one housing with two or more inlet for the mixing components and an outlet as well as a shaft with screw threads and a drive means for the rotation of the shaft, wherein the mixer has a mixing zone in which oppositely directed threaded grooves are present on the shaft and on the internal wall of the housing, and at least one inlet is arranged in the mixing zone with oppositely directed threaded grooves.

Further zones that do not have oppositely directed threaded grooves may be connected to the mixing zone with oppositely directed threaded grooves.

The product is conveyed by means of the oppositely directed thread shape.

Within the threaded grooves a rotating flow is produced by the opposite movement of the housing and shaft. On each engagement with a threaded groove of the other structural part, an exchange of material takes place between the two threaded grooves. Since the mixing is thus based on a redistribution of the material to be mixed followed by separation and joint conveyance, there is a significantly reduced energy input per mixing action compared to mixers that are based on kneading the product, for example extruders. This is particularly important when thermally sensitive materials are being mixed.

In a preferred embodiment the pitch of the threaded grooves of the screw thread and/or of the internal wall of the housing is chosen so that it is 0.5 to 2 times the circumference of the shaft, particularly preferably 0.8 to 1.2 times the circumference of the shaft.

The maximum conveying action is achieved when the pitch of the threaded grooves is approximately equal to the shaft circumference.

In a preferred modification the number of threaded grooves of the screw thread and/or of the internal wall of the housing in a radial section is greater than 16. A short mixing time is achieved due to the large number of mixing engagements per revolution.

In a particularly preferred modification the length of the mixing zone is two to five times the shaft diameter. The number of mixing engagements, starting from 16 threaded grooves, is then at least 60 to 150 depending on the counterpressure at the outlet, with the result that a complete mixing is achieved. A longer exposure of the product to mixing forces is not necessary.

In a further preferred modification the numbers of threaded grooves in a radial section in the housing and on the shaft are relatively prime. In this way possible pressure pulsations are avoided during the conveyance.

In a further preferred modification the drive means for the shaft is designed so that the rotational speed of the shaft is more than 2800 revolutions per minute.

In a particularly preferred modification the mathematical product of the rotational speed and number of threaded grooves on the shaft in the radial section of the shaft is greater than 50000 mixing engagements per minute.

A preferred mixer is designed so that an inlet for one of the components to be mixed is arranged in the first quarter of the mixing zone.

Particularly preferably a plurality of inlets are arranged in the first quarter of the mixing zone, which are distributed on the circumference of the housing.

In a particularly preferred variant of the mixer an annular groove is arranged in the region of the inlet on the inner wall of the housing.

With regard to the mixing of highly viscous reactive systems, the object is solved according to the invention by a process in which the mixing of the reactants takes place in a mixer according to the invention.

The invention also provides a process for the mixing of rapidly reacting educts, in particular educts of a chemical reaction, in a dynamic mixer, characterized in that the mixing of the reactants takes place in the mixing zone of the mixer according to the invention.

Preferably a process is employed in which one reactant is fed through a separate inlet directly into the mixing zone. In this way a reaction before the intensive mixing is prevented.

Particularly preferred is a process in which the reactants are diisocyanates on the one hand and dialcohols and/or diamines on the other hand. Particularly for these rapidly reacting systems, the short mixing times of the mixer according to the invention enables the molecular weight distribution of the resultant polymer to be adjusted more narrowly.

Particularly preferred is a process in which the reactive system consists of diisocyanates on the one hand and dialcohols and/or diamines on the other hand, in which a reactant is fed through a separate inlet directly into the mixing zone and the mathematical product of the rotational speed and number of threaded grooves is greater than 50000 mixing engagements per minute.

Suitable dialcohols are all diols suitable for the production of polyurethane(urea), for example polyether diols or polyester diols. Suitable diamines are all diamines suitable for polyurethane(urea) production, for example ethylenediamine or propylenediamine. Suitable diisocyanates are all diisocyanates suitable for polyurethane(urea) production, for example aromatic diisocyanates. The aforementioned polyurethane starting materials may also be reacted in the mixer according to the invention after the prepolymer process. The aforementioned polyurethane reaction systems are in principle known to the person skilled in the art and are described for example in specification EP 579 979 A2, which is cited here as a reference in the disclosure.

The invention furthermore provides for the use of the mixer according to the invention for the production of polyurethane(urea) spinning solutions.

### EXAMPLES

### Example 1

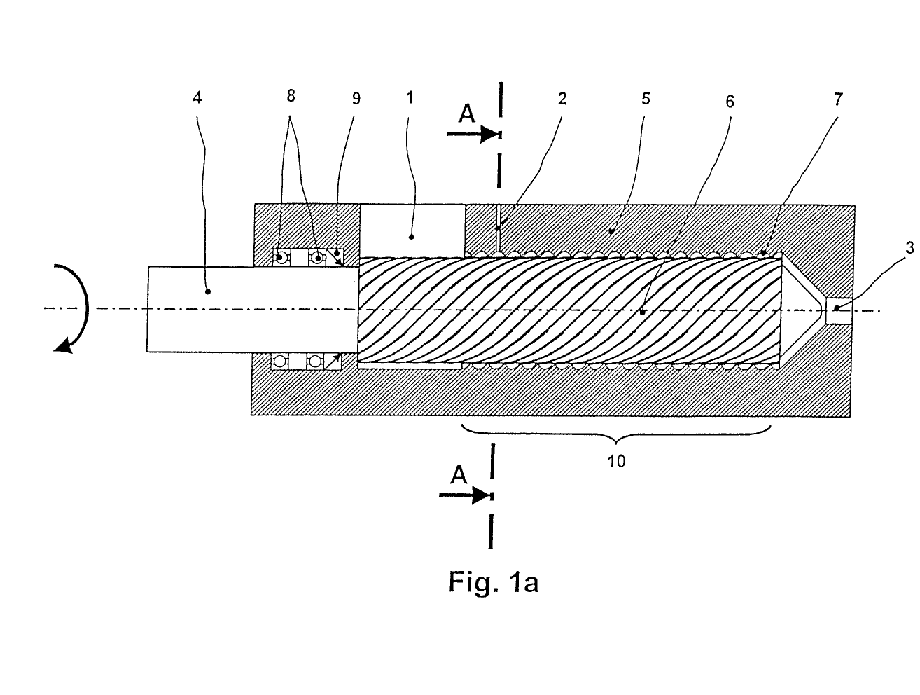

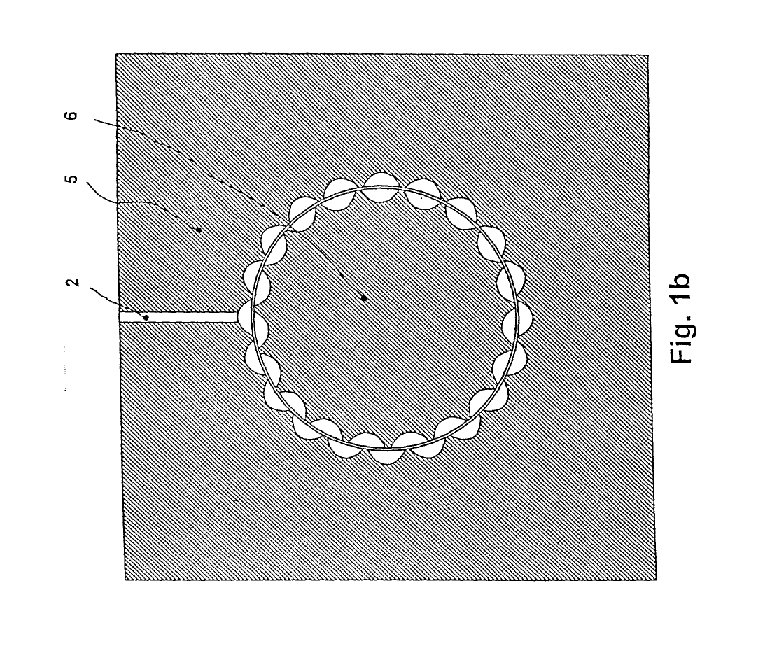

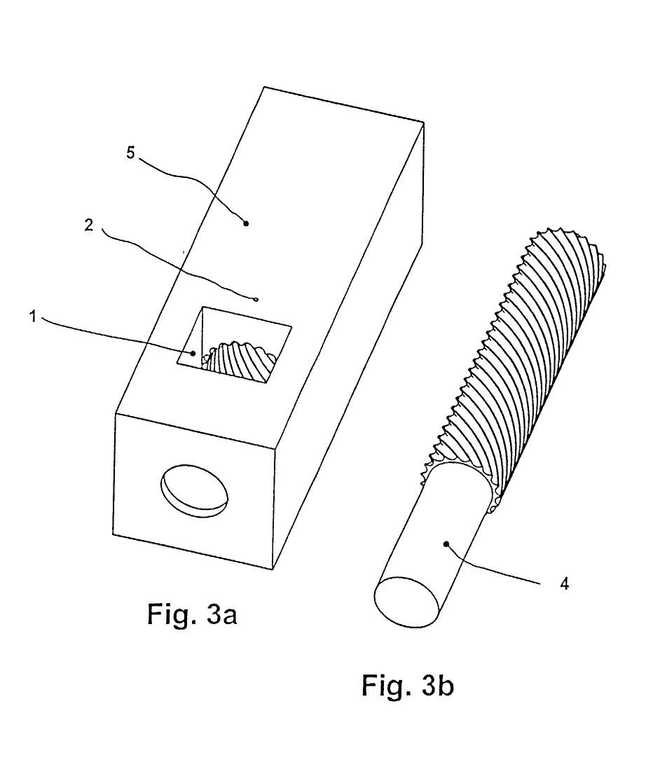

FIG. 1a shows a mixer according to the invention. The housing is shown in longitudinal section. A representation of the drive means was omitted for reasons of clarity. The mixer includes an inlet shaft 1 for the main educt, which is conveyed by the shaft 4 to the mixing zone 10. A further inlet 2 is provided at the start of the mixing zone 10. In the region of the mixing zone 10 the shaft 4 and internal wall of the housing 5 have respectively a screw thread 6 and screw thread 7 arranged in opposite directions (see also FIGS. 3a and 3b). The bearing (8) and the shaft seal (9) are shown only diagrammatically in FIG. 1a.

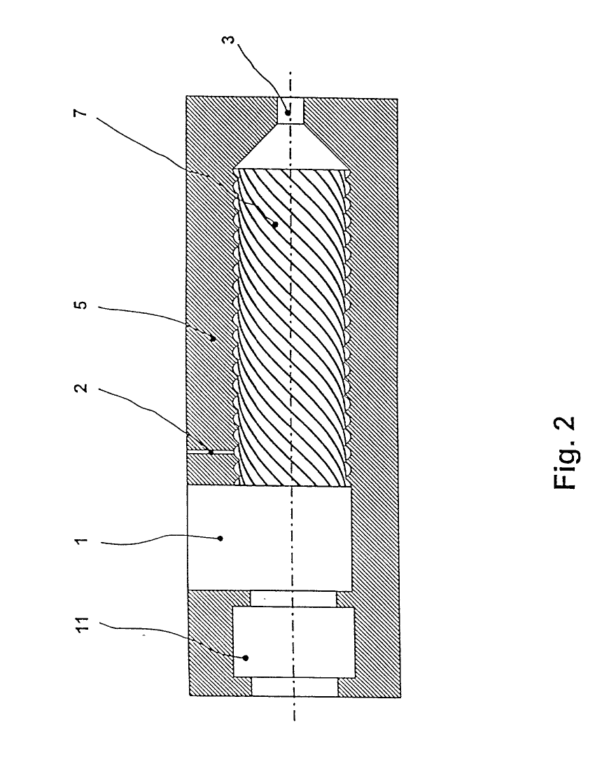

FIG. 1b shows the mixer with the inlet 2 in cross-section corresponding to A-A in FIG. 1a. In FIG. 2 the interior of the mixer is shown in longitudinal section, with the shaft 4 removed.

The shaft 4 of the mixer has 19 left-hand threaded grooves 6, and the housing 5 has 20 right-hand threaded grooves 7. The pitch of the threaded grooves (6) was chosen to be equal to the shaft circumference.

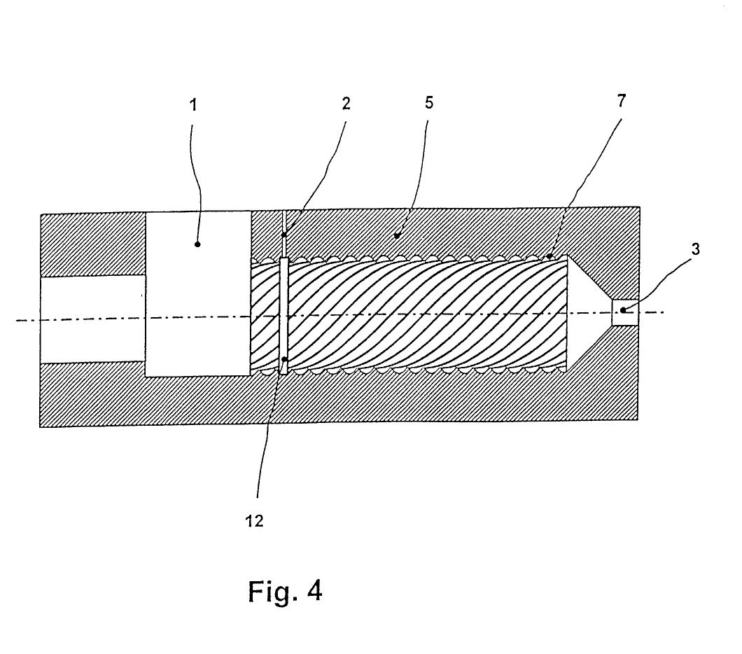

FIG. 4 shows an alternative design of the inlet (2) with an annular groove (12) in the internal wall of the housing (5) for the simultaneous feed of the material to be mixed to the circumference of the shaft (4).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A dynamic mixer comprising at least one housing with two or more inlets for the mixing components, and an outlet as well as a shaft with a screw thread and a drive means for the rotation of the shaft, wherein the mixer has a mixing zone in which oppositely directed threaded grooves are provided on the shaft and on the internal wall of the housing, and at least one inlet is arranged in the mixing zone with oppositely directed threaded grooves.

2. The mixer of claim 1, wherein the pitch of the threaded grooves of the screw thread and/or of the internal wall of the internal wall of the housing is 0.5 to 2 times the circumference of the shaft.

3. The mixer of claim 1, wherein the number of threaded grooves of the screw thread and/or of the internal wall of the housing in a radial section is greater than 16.

4. The mixer of claim 1, wherein the length of the mixing zone is 2 to 5 times the diameter of the shaft.

5. The mixer of claim 1, wherein the number of threaded grooves of the screw thread and/or of the internal wall of the housing in a radial section is relatively prime.

6. The mixer of claim 1, wherein the drive means of the shaft generates a rotation speed of at least 2800 revolutions per minute.

7. The mixer of claim 1, wherein the mathematical product of the minimum rotational speed of the drive means and the number of the threaded grooves on the shaft viewed in a radial section is greater than 50000 mixing engagement per minute.

8. The mixer of claim 1, wherein an inlet is provided in the first quarter of the mixing zone.

9. The mixer of claim 1, wherein plurality of inlets are provided in the first quarter of the mixing zone, which are distributed over the circumference of the house.

10. The mixer of claim 1, wherein an annular groove is provided in the region of the inlet on the internal wall of the housing.

11. A process for mixing rapidly reacting educts, in a dynamic mixer, wherein the mixing of the reactants takes place in the mixing zone of a mixer according to claim 1.

12. The process of claim 11, wherein a reactant is fed directly into the mixing zone through a separate inlet.

13. The process of claim 11, wherein the reactants are i) diisocyanates, and ii) dialcohols and/or diamines.
